(19) United States
(12) Patent Application Publication
(10) Pub. No.: US 2004/0085184 A1
(43) Pub. Date: May 6, 2004

(54) Redundant safety system of a vehicle

(76) Inventor: Volker Sigmund, Malsch (DE)

Correspondence Address: Mark Ungerman, Fulbright & Jaworski, 801 Pennsylvania Avenue NW, Washington, DC, 20004-2623, US

(21) Appl. No.: 10/362,839

(22) PCT Filed: Aug. 24, 2001
(86) PCT No.: PCT/EP01/09779

(30) Foreign Application Priority Data
Aug. 30, 2000 (DE) 100 42 816.9
Aug. 8, 2001 (DE) 101 38 898.5

(51) Int. Cl. G05B 23/02; B66F 17/00

(52) U.S. Cl. 340/3.42

(57) ABSTRACT

The present invention relates to a redundant safety system for use with vehicles. The redundant safety system of the invention includes at least two sensors, and signals from the sensors are processed to calculate values for operating configuration parameters of the vehicles. If the calculated operating configuration parameter values deviate from each other or from stored predetermined safe values an error message is generated.

### BACKGROUND OF THE INVENTION

1. Field of the Invention

The present invention relates to a redundant safety system for vehicles, especially mobile working platforms, and more particularly to a redundant safety system including at least two sensors for monitoring different vehicle operating parameters so that signals from the sensors are processed to determine whether the vehicle is in a safe operating configuration.

2. Description of the Related Technology

Safety systems are known in vehicles, especially utility vehicles such as mobile working platforms, or the like. In these safety systems, when one operating parameter leaves a given range or reaches a certain setpoint, a warning indication or even countercontrol is generated in order to avoid safety-critical states. In the case of mobile working platforms, for example, the angle of a main arm or loading of a basket can be monitored, and when an operating parameter is exceeded by the main arm angle or the basket load and must be adjusted a corresponding countercontrolling signal can be generated. For safety reasons, generally the sensors that detect operating parameters are doubled, i.e. made redundant, so if a sensor is defective or fails, it is possible to fall back onto the signal from the second sensor which continues to be available.

But these prior systems have various disadvantages.

On the one hand, it is necessary for monitoring an operating parameter to have at least two identical or different sensors, which for redundant type safety systems increases costs. But on the other hand, for redundant type safety systems it is not possible to draw a conclusion as to a faulty output signal for a monitored operating parameter value since in prior safety systems a comparison of signals from the redundant two sensors are not made. This situation occurs because when physical measurements are made by the two sensors the signals from both sensors can somehow be distorted so that a safety-critical state arises. Thus, such a system can be manipulated, i.e., sensor signals distorted, so that when there is a safety-critical operating parameter measurement the pertinent sensor delivers a noncritical signal.

### SUMMARY OF THE INVENTION

Therefore an object of the invention is to make available a redundant safety system for motor vehicles that does not have the above described disadvantages, and, thus, safety-critical states effectively can be prevented and there is protection against manipulation.

The present invention includes at least two sensors for detection of different parameters and the signals of the at least two sensors can be processed and evaluated separately from one another in at least one control unit. On the one hand this arrangement has the advantage that monitored values for an operating parameter are made by only a single sensor. While, as detailed below, it is ensured by using two sensors that safety-critical states are avoided.

Thus a first output signal value is determined from the signal which has been generated from the first sensor and which represents a first operating parameter value. The same applies to the second sensor which is set up to monitor another operating parameter and to provide an output signal that represents the value of this operating parameter as determined in the control unit. These two sensors can be of the same design, but in an especially advantageous arrangement, for the sake of safety, they also can be of different design. One actual value which is to be compared for the respective monitored operating parameter is computed in the control unit from the two output signals of the two sensors, and also more than two sensors and operating parameters can be monitored. This means that a comparable actual value is determined by a different computation approach based on output signals of identical or different sensors for operating parameters which are different from one another. These comparable actual values are compared to one another so that when they deviate from one another it is possible to infer that an error exists. In this way a faulty sensor, a faulty signal or faulty determination is immediately recognized since the two comparable actual values are arrived at based on different operating parameters and different computation approaches.

In one embodiment for the invention two control units are provided, and signals from one group of sensors can be sent to each of these control units. Thus each control unit processes and evaluates signals for their group independently of the other group. Here, the respective control units (each control unit having at least one sensor or one group of sensors) determine comparable actual values that are provided to the other control unit so that when the comparable actual values deviate an error can be inferred. By this arrangement there need not necessarily be a comparison made between the actual values determined by the two control units; it is also conceivable that the comparable actual values are compared to stored setpoints, i.e., if the computed actual value exceeds or falls below a given setpoint or is outside a certain setpoint range or reaches a definable setpoint range, at least one error message is produced. It is therefore provided that two control units (computers) receiving differently acquired physical values come to comparable results using different arithmetic approaches and compare them to one another.

The presence of two or more control units moreover has the advantage that for example in mobile working platforms one control unit is installed in the driver's compartment of the vehicle of the working platform, while the second control unit can be located in the basket of working platform. Thus, for the case in which a safety-critical state is being approached or has already been reached, an error warning message can be displayed in the driver's compartment of the vehicle and also in the basket. In addition to producing and displaying an error message, actuators (driving elements) of the motor vehicle can also be triggered so that a safety-noncritical state is assumed. This sequence of events can mean, for example, in a mobile working platform that the tilt angle of the main arm is changed in direction and that overturning of the vehicle is prevented.

### BRIEF DESCRIPTION OF THE DRAWINGS

A redundant safety system is described below for purposes of explaining the invention using the example of a mobile working platform and is explained using the figures. The invention is not limited to the application in a mobile working platform, but can be used in general in motor vehicles or utility vehicles.

FIG. 1 shows a first embodiment of a redundant safety system according to the invention;

FIG. 2 shows a second embodiment of a redundant safety system according to the invention; and

FIG. 3 shows use of a redundant safety system according to the invention in a mobile working platform.

### DETAILED DESCRIPTION

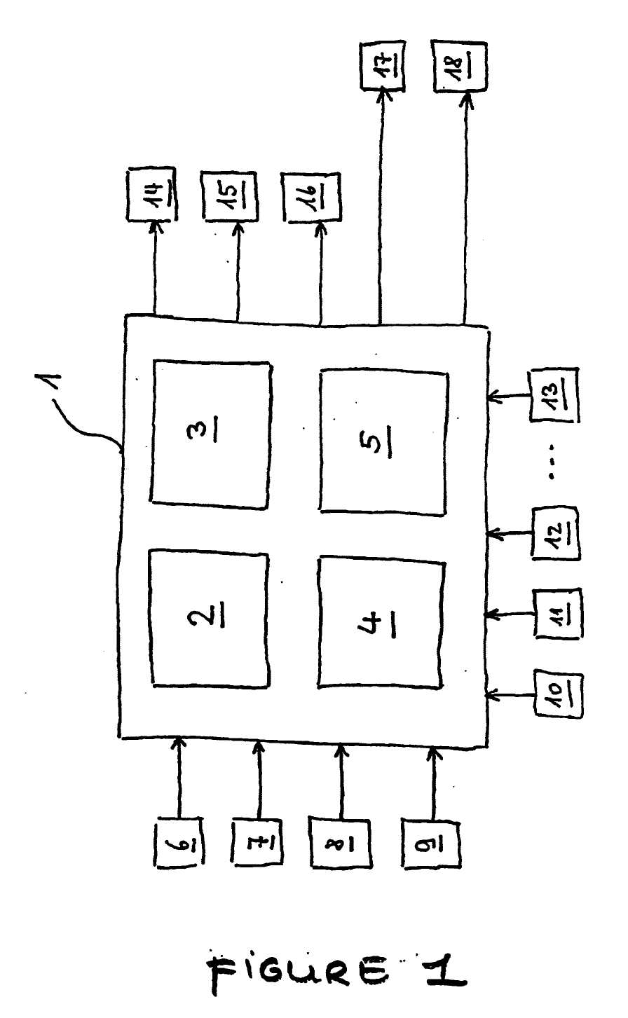

FIG. 1 shows a first embodiment of the redundant safety system for a vehicle according to the invention, especially a utility vehicle, which has a control unit 1. This control unit 1 includes an input unit 2 via which the control unit 1 can receive commands from the outside (for example, to undertake an update). Furthermore the control unit 1 includes a display unit 3 on which information about operating parameters, computed values or the state of the control unit 1 can be shown. For example, delivery for viewing of an error message via the display unit 3 is possible. Furthermore the control unit 1 includes a processor 4 and a storage unit 5. The processor 4 can process signals sent to it and evaluate them in collaboration with data from the storage unit 5, and can produce a comparable actual value or several comparable actual values.

At least two sensors ((6 to 9) and (10 to 13))which can be the same or different from one another, but which are set up to monitor different operating parameters of the vehicle, are connected to the control unit 1. Thus, in FIG. 1 it is shown for example that a first group of sensors 6 to 9 and a second group of sensors 10 to 13 are connected to the control unit 1. The number of groups or the number of sensors themselves depends on the operating parameters which are to be monitored during operation of the vehicle.

To control operation of the vehicle, identical or different actuators are provided. These actuators are shown by way of example in FIG. 1 as a first group of actuators 14 to 16 and as a second group of actuators 17, 18. The number of respective actuators or groups of actuators also depends on the number and arrangement of components of the motor vehicle which are to be controlled.

The control unit 1 is configured to produce a first actual value for example from the signals of the sensors 6 to 9 of the first group in a first computation method.

Likewise, the sensors 10 to 13 of the second group are made to acquire other operating parameters and to compute another or second actual value in a computation method different from that for sensors 6 to 9 of the first group. In any case the two computed actual values being comparable to one another, i.e. representing one operating parameter or one collective parameter. Thus, by monitoring different actual operating parameters using at least two different computation methods in the control unit 1 it is possible to compute comparable target parameter values or actual values that can be directly compared to one another. If it is ascertained from the comparison that there is a critical deviation between values or that there is a deviation of one individual actual value from a setpoint stored, for example, in the storage unit 5, then an error message can be delivered to the operator of the vehicle via the display unit 3 or at least one of actuators 14 to 18 can be triggered so that a safe state is maintained (shut-off function) or a safety-noncritical state is achieved again. The manner in which at least one actuator is triggered when a safety-critical state has been reached can likewise be stored in the storage unit 5.

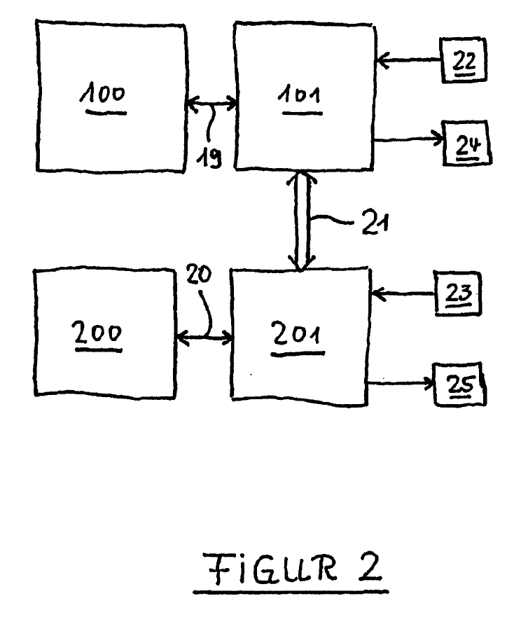

FIG. 2 shows another embodiment of a redundant safety system according to the invention with two control units, each control unit including one display and operating console 100, 200 (which correspond to the display unit 3 and the input unit 2 of the first embodiment), and one mobile control 101, 201 each. The display and operating consoles 100, 200 are connected to the mobile controls 101, 201 via data transmission links 19, 20. Likewise the two control units, especially the mobile controls 101 and 201, are connected to one another for purposes of data exchange via a data transmission link 21. At least one sensor, especially a group of sensors 22, 23 (at least two), and at least one actuator, especially a group of actuators 24, 25, are again connected to the mobile controls 101, 201. The safety system shown in FIG. 2 works using the same principle as was described already in the safety system as shown in FIG. 1. The embodiment of the safety system as show in FIG. 2 however has the advantage that for example the display and operating consoles 100 and 200 can be installed in a vehicle driver's compartment and in a vehicle basket of the working platform in order to be able to deliver corresponding information and instructions, especially error messages, to vehicle operators at these locations. The presence of the mobile controls 101 and 201 has the advantage that, for example, actuation of a basket (moving it up and down or deflecting the arm of the working platform) can be remotely controlled by an individual located next to, but outside, the vehicle or in the basket. Moreover, if necessary, the control process can be directed from the other mobile control. The controls 100/101 or 200/201 can also be made each as a control unit (analogously to the control unit 1 from FIG. 1).

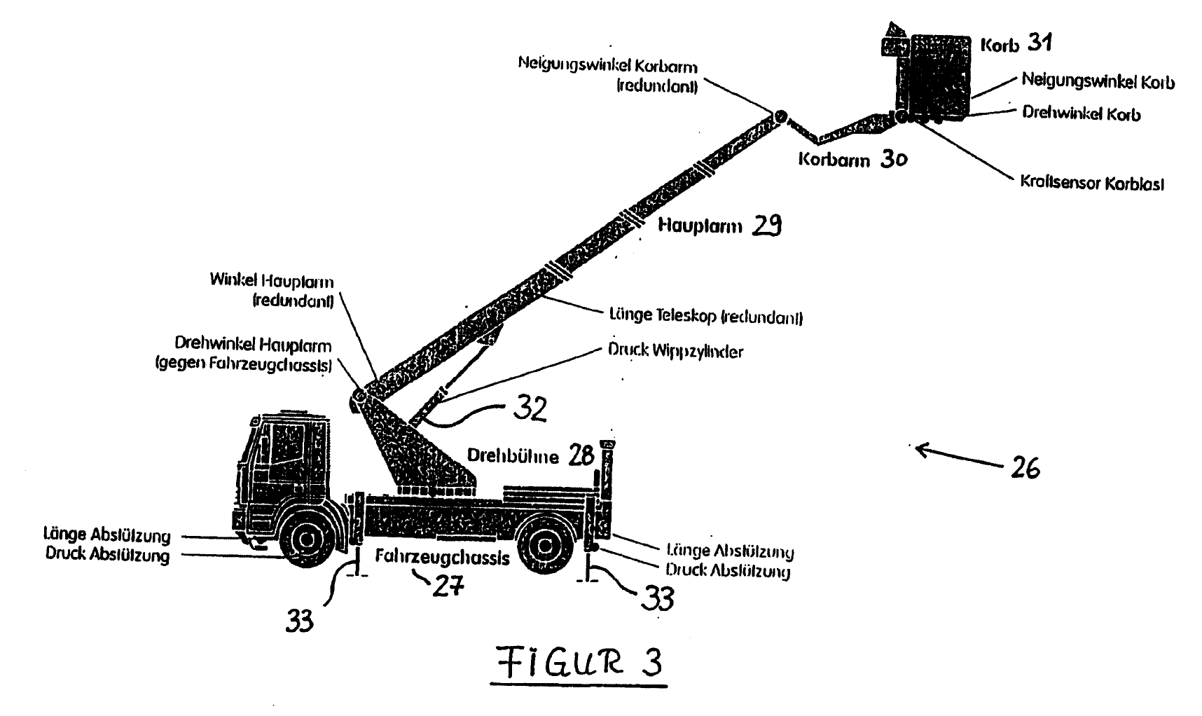

While the invention relates to any type of vehicle, but especially preferably to utility vehicles, FIG. 3 shows a preferred application of the invention for a mobile working platform 26. On a mobile vehicle chassis 27 with a driver's compartment a revolving platform 28 is installed over which there is a basket 31 located on a telescoping main arm 29 and over a movable basket arm 30. In operation of the working platform 26 the angle of the main arm 29 is adjustable as to incline by use of a hydraulic cylinder 32. Likewise there are mechanisms for causing the revolving platform 28 to move rotationally relative to the vehicle chassis 27. These mechanisms, just like the hydraulic cylinder 32, and those for adjusting the location of the basket 31 are the actuators (14-16, 17-18, and 24, 25) shown in FIGS. 1 and 2. Moreover, in FIG. 3 operating parameters (such as for example the main arm angle, tilt angle of the basket arm, basket loads etc.) are monitored by sensors (6-9, 10-13, and 22, 23) as shown in and described for FIGS. 1 and 2. Further, the length and the pressure on the hydraulic supports 33, which are necessary in the operation of the working platform 26 for stability, can be monitored and evaluated as operating parameters.

It is pointed out once again that the control units according to the invention can be made such that they can be used to monitor and control processes (for example, operation of the vehicle) or only monitor the process and then intervene (for example, by triggering an actuator) when a safety-critical state has been reached or will soon be reached in order to prevent an unsafe condition. Thus for example, the extension of the basket 31 could be stopped (shut-off function) when a danger of overturning of the vehicle is threatened.

With respect to FIG. 2, therefore, two safety systems are combined such that a comparable result is achieved with different computation methods with partially different sensors.

### 1st Approach

Main arm 19 and basket arm 30 positions, and length of the telescope arm(s) 23 are monitored. Safety shut-off and basket loads then are computed from them so that a load moment limitation (LMB) can be determined.

### 2nd Approach

Acquisition of the load and position of the basket 31 and the tilting moment is likewise computed from the aforementioned length(s) and angles and thereby the basket load is measured.

The special features consist likewise in that the force sensors are not made redundant here, but are divided into pressure measurement and force measurement. The two control units can compare by data exchange both load computations which lead to shut-off and also directly measured (geometry) values which have been computed backward (basket load from geometry and pressure).

Alternatively a system according to the invention can have all monitored quantities acquired only once, and then have only the computed and measured (basket) loads compared. When immediate recognition of a single error is required, each individual sensor output nevertheless is still monitored. An error in pressure detection or length measurement or angle measurement leads inevitably to faulty computation of the load and thus an error is recognized by direct comparison with the determined value of the force measurement.

Special advantages of this system according to the present invention relative to the direct redundant detection and computation of identical measurement quantities include:

different software executions, avoidance of identical errors in the program;

different sensors with respect to force/pressure detection in position and vehicle configuration;

the system of the present invention essentially cannot be adversely influenced with respect to shut-off safety by sensor signal manipulation; and

prior systems are relatively easy to manipulate (i.e., signal distortion) for purposes of “increasing” the reach or load of the basket.

Other signals to reduce the reach/mechanical load which is dependent on the type of operation must furthermore be made available separately to the two control units of the present invention if necessary. This is especially true for the range of rotation acquired by the rotary angle sensor or switch, and the support base.

Furthermore this basic concept also can be expanded to the base vehicle. The center of gravity of the complete superstructure above the turntable also can be computed from the detected values for moment and radius or load and position (radius) and idle moment. The support forces which occur can be computed backward from this information and the position which is detected by the angle of rotation. The length of the sliding rails which is measured by switches or analog sensors is also included here (horizontal support position).

The actual support force can be detected by pressure measurement on all four supports and can be directly compared to the computed value. Thus, a simply made rotary angle sensor can be checked. Single errors in support pressure, support length or incorrect position in the rotary range are recognized by the present invention. In this way there is additional protection against overturning by measuring support forces. At least when approaching a boundary area (the vehicle is nominally only on 3 supports) errors in the computation can be compensated for by “braces” in the chassis.

1. Redundant safety system of a motor vehicle, especially a mobile working platform (26), with sensors (6 to 13, 22, 23) for determining operating parameters of the vehicle, the sensors provide signals supplied to at least one control unit (1) for processing and evaluation, characterized in that at least two sensors are provided for monitoring different operating parameters and the signals of the at least two sensors are processed separately from one another in at least one control unit (1) are evaluated for producing comparable actual values.

2. Redundant safety system as claimed in claim 1, wherein there are two control units (1; 100, 101; 200, 201) to which the signals of at least one sensor, especially a first group of sensors (22, 23), at a time are supplied, the control units (1; 100, 101; 200, 201) process and evaluate the signals of the sensor, especially the first group of sensors independently of the other group of sensors.

3. Redundant safety system as claimed in claim 1 or 2, wherein at least one control unit (1; 100, 101; 200, 201) makes a comparison of the evaluated signals with other detected signals and/or definable signals or signal ranges.

4. Redundant safety system as claimed in claim 2 or 3, wherein the evaluated signals of one control unit are supplied to the other control unit and/or vice versa.

5. Redundant safety system as claimed in claim 3 or 4, wherein there are means for delivering an error message as a sense of a warning indication when comparison of actual values deviates from one another or an actual value deviates from a definable comparison result.

6. Redundant safety system as claimed in claim 3 or 4, wherein there are means for triggering at least one actuator when the comparison of the actual values deviates from one another or when the comparison of an actual value to a definable comparison result deviates.

7. Redundant safety system as claimed in one of the preceding claims, wherein at least two sensors are of different design.
